(19) United States
(12) Patent Application Publication
(10) Pub. No.: US 2006/0128413 A1
(43) Pub. Date: Jun. 15, 2006

(54) Method of controlling low noise amplifier in mobile communication terminal

(75) Inventors: Hong Jun Choi, Seoul (KR); Chung Jin Nam, Seoul (KR); Hyong Chan Lee, Gyounggi-do (KR); Jong Han Jeong, Seoul (KR); Jong Woo Kang, Seoul (KR)

Correspondence Address: DICKSTEIN SHAPIRO MORIN & OSHINSKY LLP, 2101 L Street, NW, Washington, DC, 20037, US

(73) Assignee: Pantech & Curitel Communications, Inc.

(21) Appl. No.: 11/211,486

(22) Filed: Aug. 26, 2005

(30) Foreign Application Priority Data
Dec. 15, 2004 (KR) 10-2004-0106003

(51) Int. Cl. H04B 7/00; H04Q 7/20

(52) U.S. Cl. 455/522

(57) ABSTRACT

The present invention relates to a method of controlling LNA in a mobile communication terminal that may improve receiving rate of mobile communication terminal in an area with multiple pseudo noise (PN). Preferably, the method may comprise the acts of: measuring Ec/Io of pilot signal received through receiving stage of the mobile communication terminal; determining whether the measured Ec/Io is higher than a predetermined standard Ec/Io or not; notifying an LNA controlling unit controlling the LNA that the measured Ec/Io is lower than the standard Ec/Io, in a case where the Ec/Io is lower than the standard Ec/Io as a result of the determination; and controlling the LNA to be operated in high gain mode according to the notification that the Ec/Io is lower than the standard Ec/Io.

### CROSS-REFERENCE TO RELATED APPLICATION

The present application is claiming priority of Korean Patent Application No. 10-2004-0106003, filed on Dec. 15, 2004, the content of which is incorporated herein by reference.

### BACKGROUND OF THE INVENTION

1. Field of the Invention

The present invention relates to a method of controlling low noise amplifier (LNA) in mobile communication terminal. More particularly, the present invention relates to a method of controlling LNA in a mobile communication terminal that may improve receiving rate of mobile communication terminal in an area with multiple pseudo noise (PN).

2. Description of the Related Art

In the related art, to improve receiving rate of code division multiple access (CDMA) mobile communication terminals, it is general to control LNA depending on received signal strength indicator (RSSI) and frequency characteristics.

The method of controlling LNA depending on the RSSI and the frequency characteristics is appropriate merely for an area with one PN or a small number of PN. However, the method is not appropriate for an area with multiple PN. In the area with multiple PN, RSSI is good but Ec/Io (ratio of signal energy within one chip duration of the pilot signal to the power spectrum) is bad. Accordingly, there are problems in that a mobile communication terminal is not able to receive a call because the mobile communication terminal is not able to receive paging signal in a standby mode.

In other words, because the method according to the related art controls the LNA depending on RSSI and frequency characteristics, without considering value of Ec/Io, there is a problem in that there is no compensation in case of low value of Ec/Io.

### BRIEF SUMMARY OF THE INVENTION

Accordingly, the present invention has been made to solve the above-mentioned problems occurring in the related art. The object of the present invention is to provide a method of controlling LNA in a mobile communication terminal that may improve receiving rate of mobile communication terminal in an area with multiple pseudo noise (PN).

In order to achieve the above objects, there is provided a method of controlling low noise amplifier (LNA) of mobile communication terminal comprising the acts of: measuring Ec/Io of pilot signal received through receiving stage of the mobile communication terminal; determining whether the measured Ec/Io is higher than a predetermined standard Ec/Io or not; notifying an LNA controlling unit for controlling the LNA that the measured Ec/Io is lower than the standard Ec/Io, in a case where the Ec/Io is lower than the standard Ec/Io as a result of the determination; and controlling the LNA to be operated in high gain mode according to the notification that the Ec/Io is lower than the standard Ec/Io.

Preferably, the method may further comprise the acts of: in a case where the measured Ec/Io is higher than a predetermined standard Ec/Io as a result of the determination, measuring RSSI of the received pilot signal and transmitting the RSSI to the LNA controlling unit; determining whether the RSSI of the received pilot signal is higher than a predetermined standard RSSI or not; and controlling the LNA to be operated in high gain mode, in a case where the RSSI of the received pilot signal is lower than the standard RSSI as a result of the determination.

Preferably, the method may further comprise the act of: controlling the LNA to be operated in any one mode between middle gain mode and low gain mode, in a case where the RSSI of the received pilot signal is higher than the predetermined standard RSSI.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates configuration of a receiving stage of a mobile communication terminal to which a method of controlling LNA according to a preferred embodiment of the present invention is applied; and

FIG. 2 is a flow chart illustrating a method of controlling LNA in a mobile communication terminal according to a preferred embodiment of the present invention.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

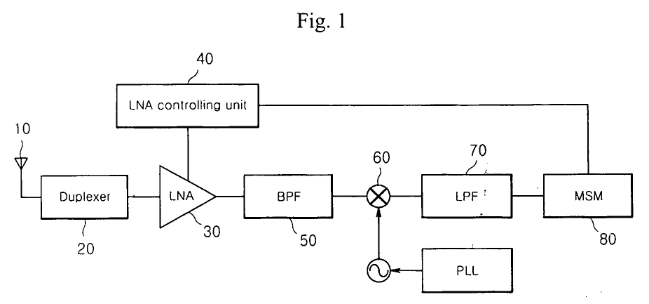

FIG. 1 illustrates configuration of a receiving stage of a mobile communication terminal to which a method of controlling LNA according to a preferred embodiment of the present invention is applied. The receiving stage comprises: an antenna 10, a duplexer 20, an LNA 30, an LNA controlling unit 40, a band pass filter (BPF) 50, a mixer 60, a low pass filter (LPF) 70 and a mobile station modem (MSM) 80.

The antenna 10 performs transmission and receipt of high frequency signal.

The duplexer 20 comprising a receiving band filter and a transmitting band filter receives signals by using one antenna 10 and separates signals to be transmitted and received signals.

The LNA 30 amplifies RF signals including noise in the air to an appropriate level while suppressing the noise, the RF signals being received through the antenna 10 and the duplexer 20. Operation modes of the LNA 30 comprise at least two modes (e.g., high gain mode, middle gain mode and low gain mode). The LNA 30 may be operated in one mode among the high gain mode, middle gain mode and low gain mode, under controls of the LNA controlling unit 40.

The LNA controlling unit 40 controls the LNA 30 to be operated in one mode among high gain mode, middle gain mode and low gain mode, based on Ec/Io and RSSI received from the MSM 80.

The BPF 50 passes only receive frequency among RF frequencies received from the LNA 30.

The mixer 60 mixes the receive frequency outputted by the BPF 50 and local signals, and converts them to base band frequency signal.

The LPF 70 removes noise included in the base band frequency signal outputted by the mixer 60.

The MSM 80 comprises CPU, vocoder for coding voices, etc. The MSM 80 performs operation/control functions and, thus, it performs main functions for input/output between mobile communication terminal and user. In a case where Ec/Io of the received pilot signal is lower than a predetermined value, the fact that Ec/Io is lower than the predetermined value is notified to the LNA controlling unit 40. In a case where Ec/Io of the received pilot signal is higher than the predetermined value, RSSI is checked and transmitted to the LNA controlling unit 40.

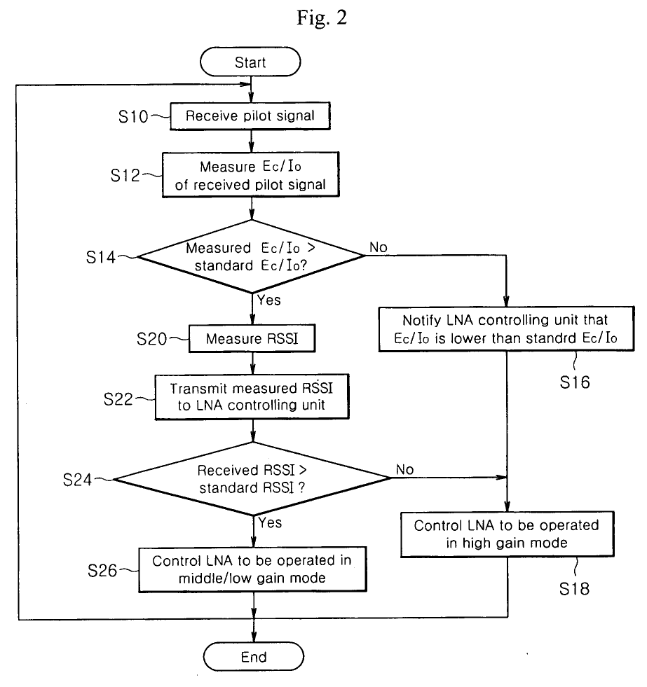

FIG. 2 is a flow chart illustrating a method of controlling LNA in a mobile communication terminal according to a preferred embodiment of the present invention.

First, the MSM 80 of mobile communication terminal receives pilot signal through receiving stage of the mobile communication terminal (S10). Then, Ec/Io of the received pilot signal is measured (S12) and whether the measured Ec/Io is higher than a predetermined standard Ec/Io or not is determined (S14).

In a case where the measured Ec/Io is not higher than the standard Ec/Io as a result of determination at S14 (that is, in a case where Ec/Io in an area where the mobile communication terminal is located is low), the fact that the measured Ec/Io is lower than the predetermined standard Ec/Io is notified to the LNA controlling unit 40 (S16).

The LNA controlling unit 40 that received from the MSM 80 the notification that the measured Ec/Io is lower than the predetermined standard Ec/Io controls the LNA 30 to be operated in high gain mode (S18). Because it could be difficult for the mobile communication terminal to receive paging signals under standby status, if Ec/Io of received pilot signal is lower than a certain level.

If the LNA 30 being operated in high gain mode after S18 amplifies signals received through the antenna 10 and duplexer 20 a lot, it is possible to reduce the number of frames that are bad for paging signals, compared to operations in middle gain mode or low gain mode. Thus, RSSI at the MSM 80 is increased.

On the other hand, in a case where the measured Ec/Io is higher than the standard Ec/Io as a result of determination at S14, RSSI is measured (S20) and the RSSI is transmitted to the LNA controlling unit 40 (S22).

The LNA controlling unit 40 that received pilot signal's RSSI from the MSM 80 through S22 determines whether the received pilot signal's RSSI is higher than a predetermined standard RSSI or not (S24).

In a case where the received pilot signal's RSSI is not higher than the standard RSSI as a result of determination at S24, the LNA controlling unit 40 controls the LNA 30 to be operated in high gain mode (S18).

Conversely, in a case where the received pilot signal's RSSI is larger than the standard RSSI as a result of determination at S24, the LNA controlling unit 40 controls the LNA 30 to be operated in middle gain mode or low gain mode (S26).

Hereinafter, the method of controlling LNA of mobile communication terminal according to the present invention will be explained with reference to FIGS. 1 and 2.

Since Ec/Io of the received pilot signal is good in an area with one or the small number of PN, RSSI is higher than a certain level. Thus, considering inter modulation distortion (IMD) characteristics or power efficiency, if it is determined that it is possible for mobile communication terminal to receive enough paging signals even though the LNA 30 is operated in middle gain mode or low gain mode, the LNA controlling unit 40 controls the LNA 30 to be operated in middle gain mode or low gain mode.

Conversely, in a case where Ec/Io of the received pilot signal is low due to multiple PN, there are possibilities of call connection failure due to failure in receiving paging signals transmitted from base stations, even though RSSI is higher than standard RSSI.

Thus, in a case where Ec/Io is low, the LNA 30 is controlled to be operated in high gain mode without regard to RSSI, so that receiving rate of mobile communication terminal is increased due to increase of whole gain in the receiving stage of the mobile communication terminal.

According to the above described method of controlling LNA of mobile communication terminal, it is possible to improve receiving rate of mobile communication terminal in an area with multiple PN by controlling the LNA to be operated in high gain mode in a case where the measured Ec/Io is lower than the standard Ec/Io.

While the present invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of controlling low noise amplifier (LNA) of mobile communication terminal comprising the acts of:
measuring Ec/Io of pilot signal received through receiving stage of the mobile communication terminal;
determining whether the measured Ec/Io is higher than a predetermined standard Ec/Io or not;
notifying an LNA controlling unit for controlling the LNA that the measured Ec/Io is lower than the standard Ec/Io, in a case where the Ec/Io is lower than the standard Ec/Io as a result of the determination; and
controlling the LNA to be operated in high gain mode according to the notification that the Ec/Io is lower than the standard Ec/Io.

2. The method of claim 1, further comprising the acts of:
in a case where the measured Ec/Io is higher than a predetermined standard Ec/Io as a result of the determination,
measuring RSSI of the received pilot signal and transmitting the RSSI to the LNA controlling unit;
determining whether the RSSI of the received pilot signal is higher than a predetermined standard RSSI or not; and
controlling the LNA to be operated in high gain mode, in a case where the RSSI of the received pilot signal is lower than the standard RSSI as a result of the determination.

3. The method of claim 2, further comprising the act of:
controlling the LNA to be operated in any one mode between middle gain mode and low gain mode, in a case where the RSSI of the received pilot signal is higher than the predetermined standard RSSI.
